(19) United States
(12) Patent Application Publication
(10) Pub. No.: US 2024/0408791 A1
(43) Pub. Date: Dec. 12, 2024

(54) THIN SHAPED STRUCTURAL ELEMENTS AND METHOD OF MAKING SAME

(71) Applicant: Technion Research & Development Foundation Limited, Haifa (IL)

(72) Inventors: Ryan POURATI, Netanya (IL); Pavel Larianovsky, Haifa (IL); Arnon Ben Tur, Tel Aviv (IL); Jacob Grobman, Tel Aviv (IL); Tom Shaked, Tel Aviv (IL); Aaron Sprecher, Tel Aviv (IL); Aharon Weissman, Moreshet (IL); Bassam Masri, Haifa (IL)

(73) Assignee: Technion Research & Development Foundation Limited, Haifa (IL)

(21) Appl. No.: 18/809,427

(22) Filed: Aug. 20, 2024

Related U.S. Application Data
(62) Division of application No. 17/266,708, filed on Feb. 8, 2021, now abandoned.
(60) Provisional application No. 62/716,413, filed on Aug. 9, 2018.

(51) Int. Cl. B28B 1/20; C04B 20/00; C04B 28/34; C04B 103/20; C04B 111/56

(52) U.S. Cl. CPC B28B 1/20; C04B 20/0048; C04B 28/342; C04B 28/344; C04B 2103/20; C04B 2111/56

(57) ABSTRACT

Disclosed is a method of fabricating a construction element. The method may include assembling a mold on a rotational casting machine; rotating the mold around at least two axes at a predetermined speed; providing a first portion of magnesium silico-phosphate cement (MSPC) mix, having an altered hardening rate, to the mold while rotating the mold until at least a portion of the mold's walls is covered by a first layer of the MSPC mix; and rotating the mold until the MSPC mix is hardened to a predetermined degree.

### CROSS REFERENCE TO RELATED APPLICATIONS

This application is a divisional of U.S. patent application Ser. No. 17/266,708, filed Feb. 8, 2021, published as US 2021/0308900, which is a National Phase of PCT Patent Application No. PCT/IL2019/050898 having an International Filing Date of Aug. 8, 2019, which claims the benefit of priority under 35 USC § 119 (e) of U.S. Provisional Patent Application No. 62/716,413 filed on Aug. 9, 2018. The contents of the above applications are all incorporated by reference as if fully set forth herein in their entirety.

### TECHNICAL FIELD OF THE INVENTION

The invention generally relates to methods of making shaped structural elements and more precisely to novel methods of making shaped structural elements from a magnesium silico-phosphate cement.

### BACKGROUND OF THE INVENTION

Making structural elements in the construction industry has been a challenge since ancient times. The more curved and complex the structural elements is, the greater is the difficulty in producing it. Casting cements into a shaped mold, using gravitational casting methods, allows limited geometrical shapes to be fabricated, and the making of three-dimensional (3D) hollow objects in a single casting, almost impossible.

Such 3D hollow objects can be made by using rotational casting. However, this technique is limited to the use in casting polymers and metals, which have the required hardening/solidification time and the required flowing properties. Rotational casting methods use a hollow mold (usually heated to a temperature that may ensure uniform flow of the cast material) fed with a flowing material (e.g., molten metal or molten polymer or fluid polymer system which can harden at room temperature by cross-linking) while being rotated around at least two axes. During the rotation the flowing casting material disperses and sticks to the walls of the mold, forming a layer. The layer is allowed to harden while the mold continues to rotate until a desired hardness is reached and the cast object is taken out of the mold.

Commonly used inorganic cements are unsuitable for the use in rotational casting for various reasons. The hardening time of cements is usually several hours, but special formulations can be made that harden in less than an hour. Yet, their flowability is not adequate for rotational casting. Therefore, current construction methods do not utilize rotational casting. Complex hollow or heavily curved elements made from cements are usually produced by connecting simpler elements to form the more complex ones.

Accordingly, there is a need to find a way to utilize the advantages of rotational casting to be used with inorganic cements, which can provide performance superior to prefabricated rotational cast components using polymer, such as environmental stability and fire endurance.

### SUMMARY OF EMBODIMENTS OF THE INVENTION

Some aspects of the invention may be directed to method of fabricating a construction element. The method may include assembling a mold on a rotational casting machine; rotating the mold around at least two axes at a predetermined speed; providing a first portion of magnesium silico-phosphate cement (MSPC) mix, having an altered hardening rate, to the mold while rotating the mold until at least a portion of the mold's walls is covered by a first layer of the MSPC mix; and rotating the mold until the MSPC mix is hardened to a first predetermined degree.

In some embodiments, the method may further include: providing a second portion of MSPC mix to the mold while rotating the mold until at least the portion of the mold's walls is covered by a second layer of the MSPC mix; and rotating the mold until the second layer of the MSPC mix is harden to a second predetermined degree. In some embodiments, at least one of: the first hardening degree and the second hardening degree is the hardening degree which allow demolding of the MSPC construction element.

In some embodiments, the geometry of the mold may include one or more curved surfaces to be covered by the MSPC mix. In some embodiments, the layer of the MSPC mix covering at least the portion of the mold's walls may have a thickness of between 0.5 cm to 2.5 cm. In some embodiments, the layer of the MSPC mix covering at least the portion of the mold's walls may have a thickness deviation of at most 5 mm. In some embodiments, the MSPC mix may include a retarder that may allow the MSPC mix to harden to the degree for at most 30 minutes. In some embodiments, the retarder is in an amount that may allow the MSPC mix to harden to the degree for 10-20 minutes.

In some embodiments, the degree of hardening may be determined such that the extracted hardened MSPC does not undergo deformation during the demolding. In some embodiments, the MSPC mix may include: a phosphate salt or acid; an aggregate phase; fibers, for example, mono-filament or multi-filament and a retarder in an amount of between about 0.05% and about 5% by weight based upon the weight of dry cement.

In some embodiments, the method may further include: adding to the MSPC mix one or more color pigments for achieving a desired color. In some embodiments, the method may further include: adding to the MSPC mix one or more textural additives for achieving a desired texture.

Some additional aspects of the invention may be related to a construction element, that may include: one or more thin walls having a thickness of at most 2.5 cm, the thin walls may be made from a dry magnesium silico-phosphate cement (MSPC) mix. In some embodiments the MSPC mix may include: a phosphate salt or acid; an aggregate phase; fibers, for example, mono-filament or multi-filament and a retarder in an amount of between about 0.05% and about 5% by weight based upon the weight of dry cement.

In some embodiments, at least one wall of the one or more thin walls may be a curved wall. In some embodiments, the one or more walls may have a thickness of between 0.5 cm to 2.5 cm. In some embodiments, the one or more walls may have a thickness deviation of at most 5 mm.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are flowcharts of methods of fabricating a construction element according to some embodiments of the invention;

FIGS. 2A-2C are illustrations of three views of a rotational casting machine according to some embodiments of the invention;

FIGS. 3A and 3B are illustrations of molds for rotational casting machine according to some embodiments of the invention;

FIGS. 4A and 4B are illustrations of an isomeric view and a cross-section of a construction element according to some embodiments of the invention;

FIGS. 5A and 5B are illustrations of an isomeric view and a cross-section of a construction element according to some embodiments of the invention; and

FIGS. 6A-6C are illustrations of assembled construction elements according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Some aspects of the invention may be related to the use of an advanced type of a magnesium silico-phosphate cement (MSPC) that has an altered hardening rate in a casting method previously considered unsuitable for casting cements. In some embodiments, the MSPC may be cast into a mold of a rotational casting machine to form a complex, and optionally hollow, cast construction element or object.

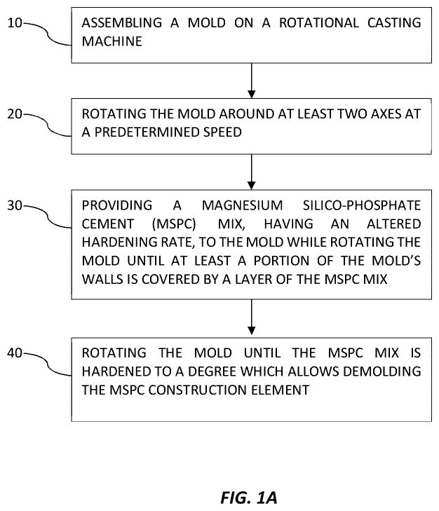

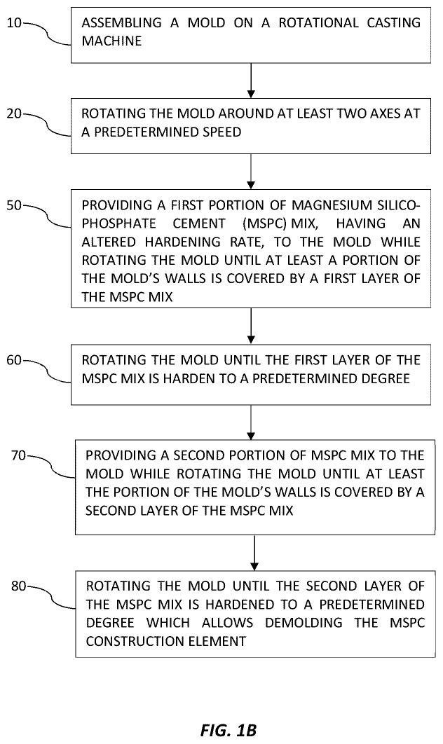

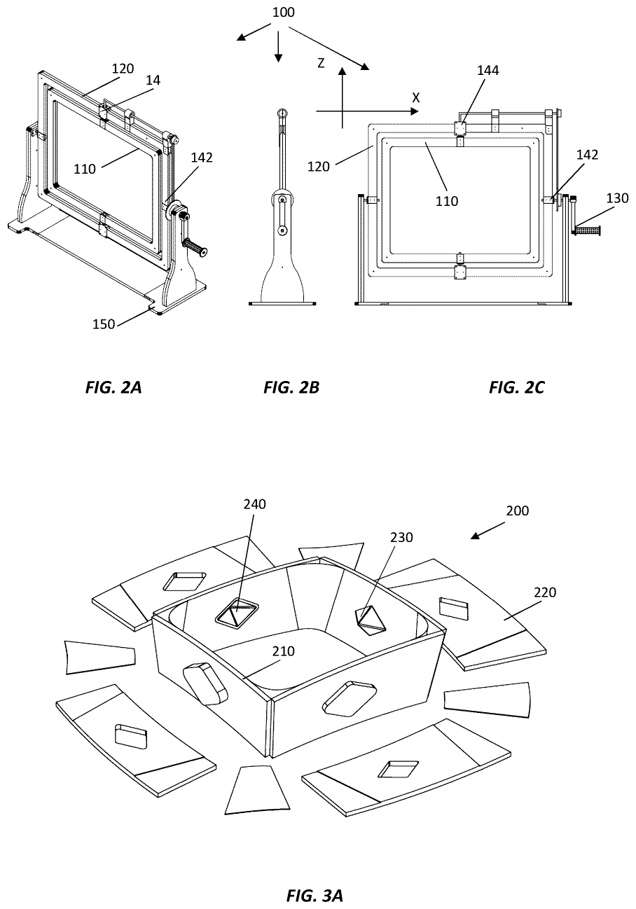

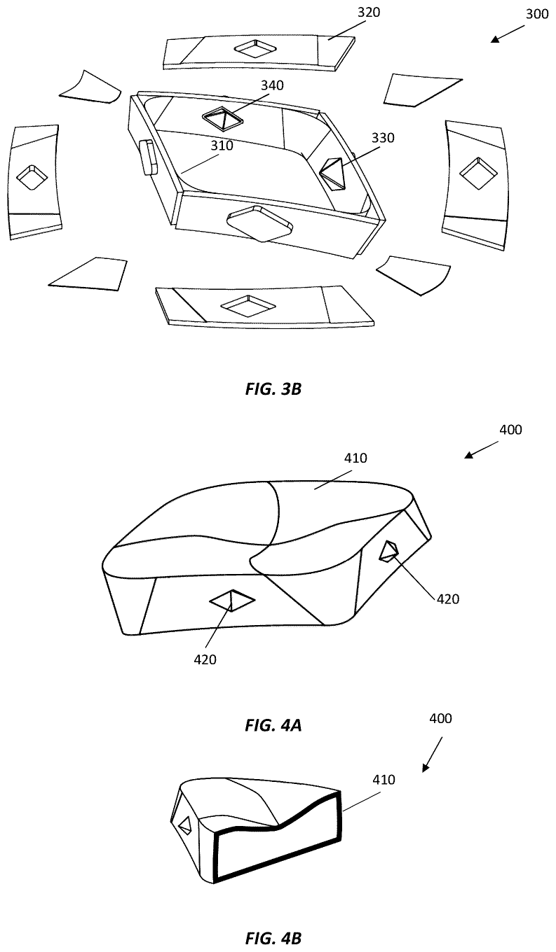

Reference is now made to FIG. 1 which is a flowchart of a method of fabricating a construction element according to some embodiments of the invention. In step 10, a mold may be assembled on a rotational casting machine. For example, a mold 200 or a mold 300, illustrated in FIGS. 3A and 3B may be assembled into a rotational casting machine 100 illustrated in FIGS. 2A-2C. Molds 200 or 300 may have any desired shape that may allow rotationally casting a construction element having any desired shape. For example, a curved shape, a hollow shape, a curved hollow shape (as illustrated in FIGS. 4-6) and the like. Molds 200 or 300 may be connected to an inner frame 110 of rotational casting machine 100 using any known method, for example, clips, screws, bolts and the like. As should be understood by one skilled in the art, the design and shape of rotational casting machine 100 and molds 200 and 300 are given as an example only, and the invention is not limited to these specific designs. Any rotational casting machine and any molds for rotational casting machine are included in the scope of the invention.

In step 20, the mold may be rotated around at least two axes at a predetermined speed. For example, Molds 200 or 300 may be rotated around two perpendicular axes X and Z illustrated in FIG. 2C. The speed may be determined to allow uniform coverage of at least some of the walls of the molds. In some embodiments, the speed may be determined based on the type and composition of the cement used in the rotational casting. The speed may be determined using experimental methods or calculated based on the flowing properties of the cement.

In step 30, an MSPC mix, having an altered hardening rate, may be provided to the mold while rotating the mold until at least a portion of the mold's walls is covered by a layer of the MSPC mix. The MSPC mix may include: MgO and a phosphate salt or acid selected from the group consisting of: (a) a phosphate salt or acid of the general formula MxHyPO₄ (1≤x≤3, y=3−x), where M is selected from the group consisting of H, Li, Na, K, Rb, Cs, NH₄, and any combination of the above; (b) any other phosphate salt or acid that after mixing with water will provide a binder product characterized by the empirical chemical formula MMgPO₄·6H₂O, and (c) any combination of the above. In some embodiments, the mix may further include an aggregate phase selected from the group containing (a) CaSiO₃, (b) SiO₂, (c) fly ash, (d) sea sand, and (e) any combination thereof; fibers made of mono filaments or multiple filaments, and a fluorine-containing additive. In some embodiments, water may be added in sufficient quantity to enable hydraulic hardening of the cement as well as to provide adequate flow properties. In some embodiments, additives may be added for further control of setting and hardening time as well as flow properties.

In some embodiments, the fluorine-containing additive may be a retarder for controlling the hardening rate of the mix. In some embodiments, the retarder is selected from the group consisting of (a) alkali metal salts of [M′F₆]n-, (b) alkaline earth metal salts of [M′F₆]n-, and (c) HnM′F₆, wherein n represents a positive integer and M′ is selected from the group consisting of (a) Ti (n=2), (b) P (n=1), (c) Zr (n=2), (d) Sb (n=1), and (e) Al (n=3). In some embodiments, the amount of retarder may be between about 0.05% and about 5% by weight based upon the weight of dry cement. In some embodiments, the retarder may be selected from the group consisting of MxTiF₆ where x=2 when M=alkaline metal. X=1.

In some embodiments, the MSPC mix may further include one or more color pigments for achieving a desired color. In some embodiments, the MSPC mix may further include one or more textural additives for achieving a desired texture.

In some embodiments, rotary casting machine 100 may rotate the mold while the MSCP mix is continuously being provided, until a layer of between 0.5 cm to 2.5 cm with a thickness deviation of at most 5 mm is formed on at least a portion of the walls of the mold. In some embodiments, the entire walls of molds 200 or 300 may be covered by a layer of the MSPC mix to form a curved hollow structural element.

In step 40, the mold may be rotated until the MSPC mix is hardened to a degree which allows demolding the MSPC construction element. In some embodiments, the retarder may be selected to harden the MSPC mix to the desired degree after, at most, 30 minutes, for example after at most, 10 minutes, 15 minutes, 20 minutes or 25 minutes. In some embodiments, the degree of hardening may be determined such that the demolded MSPC does not undergo deformation during the demolding operation.

Reference is now made to FIG. 1B which is a flowchart of a method of fabricating a construction element according to some embodiments of the invention. Steps 10 and 20 of the method of FIG. 1B are substantially similar to steps 10 and 20 of the method of FIG. 1A. In step 50, a first portion of MSPC mix, having an altered hardening rate, may be provided to the mold while rotating the mold until at least a portion of the mold's walls is covered by a first layer of the MSPC mix. The MSPC mix may be substantially the same as the MSPC mix disclosed in step 30 of the method of FIG. 1. For example, a first portion of a pre-prepared MSPC mix may be provided to a rotating mold 200 or 300 as to form a first layer, having a thickness of 0.5-2.5 cm, with a thickness deviation of at most 5 mm. The mold may continue to rotate, in step 60, until the first layer of the MSPC mix is hardened to a predetermined degree. For example, the degree of hardening may be determined as to allow adding a second layer of the MSPC mix on top of the first layer while avoiding mixing of the material in both layers. In some embodiments, the mold may be rotated for about 10 minutes.

In step 70, a second portion of the MSPC mix may be provided to the mold while rotating the mold until at least the portion of the mold's walls may be covered by a second layer of the MSPC mix. The MSPC mix may be substantially the same as the MSPC mix disclosed in step 30 of the method of FIG. 1. In some embodiments, the second portion of MSPC mix may be different and may include a different composition than the first portion of the MSPC mix. For example, a second portion of a pre-prepared MSPC mix may be provided to a rotating mold 200 or 300 as to form a second layer on top of the first layer. In some embodiments, the second layer may have a thickness of 0.5-2.5 cm, with a thickness deviation of at most 5 mm. The mold may continue to rotate, in step 80, until the second layer of the MSPC mix is hardened to a predetermined demolding degree. In some embodiments, the degree of hardening may be determined such that the extracted hardened MSPC does not undergo deformation during the extraction.

In some embodiments, more than two layers of the MSPC mix may be applied during the fabrication of the construction element and steps 50-60 and/or 70-80 may be repeated.

Reference is now made to FIGS. 2A-2C which are an isometric view, side view and front view of a rotational casting machine according to some embodiments of the invention. A rotational casting machine 100 may include an internal frame 110, an external frame 120, a first gear 142 configured to rotated external frame 120 around a first axis, a second gear 144 configured to rotated internal frame 110 around a second axis and an actuator 130 for providing rotational movement to gears 142 and 144. Rotational casting machine 100 may further include a base 150 for supporting frames 110, 120 and the mold.

Internal frame 110 may be configured to hold and be connected to a mold. Internal frame 110 may include any connectors or connecting means for connecting and holding the mold. The connectors may be bolts, screws, clamps or any other suitable connecting means. Internal frame 110 may be made from any suitable material, for example, wood, light metallic alloys, polymers and the like. Internal frame 110 may be configured to be rotated around a first axis (e.g., the Z axis illustrated in FIG. 2C) due to a rotational movement provided by actuator 130 via second gear 144.

External frame 120 may be configured to rotate internal frame 110 around a second axis (e.g., the X axis illustrated in FIG. 2C) due to a rotational movement provided by actuator 130 via first gear 142. External frame 120 may be made from any suitable material, for example, wood, light metallic alloys, polymers and the like.

Actuator 130 may include any suitable device that may provide a rotational movement. Actuator 130 may include a manual crank handle (illustrated in FIGS. 2A-2C), an electric motor, a hydraulic motor or the like. In some embodiments, actuator 130 may be include at least one of: a controllable motor and a controllable gear and may further be configured to be controlled by a controller (not illustrated).

Reference is now made to FIGS. 3A and 3B which are illustrations of molds for rotational casting of MSPC mix according to some embodiments of the invention. Each of molds 200 and 300 may include a plurality of walls 210 and 310 respectively. In some embodiments at least one of walls 210 and/or 310 may be curved. In some embodiments, all the walls included in molds 200 and 300 may be curved. In some embodiments, molds 200 and 300 may further include inlets (not illustrated) for providing the MSPC mix to the molds.

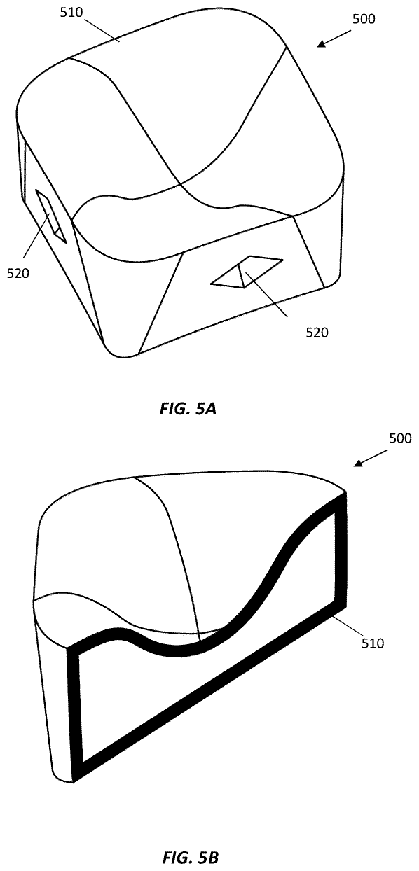

In some embodiments, the curved walls may include a flexible fabric supported on frame elements 220 or 320. In some embodiments, the walls may include a plurality of woven threads supported on frame elements 220 or 320. In some embodiments, walls 210 and 310 may be made from substantially rigid material, such as wood, light metals, polymers and the like. In some embodiments, walls 210 and 310 may further include protrusions 230 and 330 respectively and/or recesses 240 and 340 respectively. In some embodiments, protrusions 230 and 330 may be configured to form recesses in the cast construction element and recesses 240 and 340 may be configured to form protrusions in the cast construction element (as illustrated in FIGS. 4-5). In some embodiments, a recess in a first cast construction element may be configured to accommodate a protrusion of a second cast construction element, as to allow a connection of the first casted construction element to the second casted construction element.

Reference is now made to FIGS. 4A and 4B which are illustrations of an isomeric view and a cut in a construction element according to some embodiments of the invention. A construction element 400 may include one or more thin walls 410 having a thickness of at most 2.5 cm. In some embodiments, the thin walls are made from a dry magnesium silico-phosphate cement (MSPC) mix. In some embodiments, the MSPC mix may include MgO, a phosphate salt or acid, an aggregate phase and a retarder in an amount of between about 0.05% and about 5% by weight based upon the weight of dry cement mix. In some embodiments, the MSPC mix may include fibers and/or any one of the compounds disclosed herein above.

In some embodiments, at least one wall 410 of the one or more thin walls may be a curved wall. In some embodiments, all walls 410 of element 400 may be curved. In some embodiments, one or more walls 410 may have a thickness of between 0.5 cm to 2.5 cm. In some embodiments, one or more walls 410 may have a thickness deviation of at most 5 mm. In some embodiments, construction element 400 may be a hollow element.

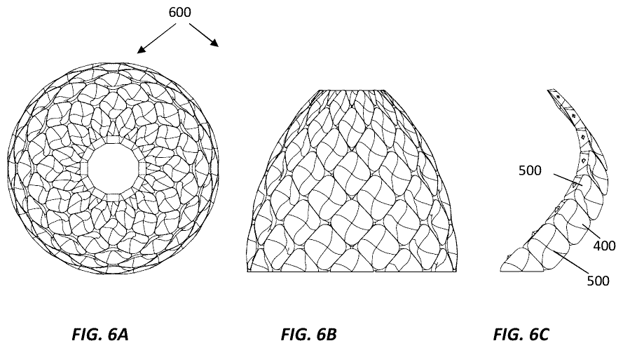

In some embodiments, construction element 400 may further include one or more protrusions 420. In some embodiments, a protrusion 420 of a first construction element 400 may be configured to be accommodated or inserted into recess 520 of a second construction element 500, illustrated in FIGS. 5A and 5B, as to connect first construction element 400 and second construction element 500, for example, by dry connection induced by an anchorage obtained between the protruding and recessed geometries on the face of the construction element (e.g. 420 and 520) or strengthening of this connection using glues or MSPC mix, as illustrated in FIGS. 6A-6B.

Reference is now made to FIGS. 5A and 5B which are illustrations of an isomeric view and a cut in a construction element according to some embodiments of the invention. A construction element 500 may include one or more thin walls 510 having a thickness of at most 2.5 cm. In some embodiments, the thin walls are made from a dry MSPC mix that may include any of the compounds disclosed herein above.

In some embodiments, at least one wall 510 of the one or more thin walls may be a curved wall. In some embodiments, all walls 510 of element 500 may be curved. In some embodiments, one or more walls 510 may have substantially the same thickness and thickness deviation as walls 410. In some embodiments, construction element 500 may be a hollow element.

In some embodiments, construction element 500 may further include one or more recesses 520 each being configured to accommodate a protrusion such as protrusion 420 of element 400.

Reference is now made to FIGS. 6A-6C which are illustrations of assembled construction elements according to some embodiments of the invention. FIGS. 6A and 6B are side view and top view and top view of a conic dome 600 made from a plurality of construction elements such as construction elements 400 and 500. FIG. 6C shows an initial stage in the assembling of construction elements 400 and 500 into conical dome 600. In some embodiments, alternating elements 400 and 500 may be connected together to form conical dome 600, The elements may be connected by dry connection induced by an anchorage obtained between the protruding and recessed geometries on the face of the construction elements (e.g. 420 and 520) or by strengthening of this connection using glues or MSPC mix, as illustrated in FIGS. 6A-6B.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of fabricating a construction element, comprising:
assembling a mold on a rotational casting machine;
rotating the mold around at least two axes at a predetermined speed;
providing a first portion of magnesium silico-phosphate cement (MSPC) mix, having an altered hardening rate, to the mold while rotating the mold until at least a portion of the mold's walls is covered by a layer of the MSPC mix; and
rotating the mold until the MSPC mix is hardened to a first predetermined degree.

2. The method according to claim 1, further comprising:
providing a second portion of MSPC mix to the mold while rotating the mold until at least the portion of the mold's walls is covered by a second layer of the MSPC mix; and
rotating the mold until the second layer of the MSPC mix is hardened to a second predetermined degree.

3. The method according to claim 1, wherein at least one of the first predetermined degree and the second predetermined degree is a hardening degree which allows demolding of the MSPC construction element.

4. The method according to claim 1, wherein a geometry of the mold comprises one or more curved surfaces to be covered by the MSPC mix.

5. The method according to claim 1, wherein the layer of the MSPC mix covering at least the portion of the mold's walls has a thickness of between 0.5 cm to 2.5 cm.

6. The method according to claim 1, wherein the layer of the MSPC mix covering at least the portion of the mold's walls has a thickness deviation of at most 5 mm.

7. The method according to claim 1, wherein the MSPC mix comprises a retarder that allows the MSPC mix to harden to the degree at for at most 30 minutes.

8. The method of claim 7, wherein the retarder is in an amount that allows the MSPC mix to harden for 10-20 minutes.

9. The method according to claim 1, wherein the degree of hardening is determined such that the extracted hardened MSPC does not undergo deformation during demolding.

10. The method according to claim 1, wherein the MSPC mix comprises:
MgO;
at least one of: a phosphate salt and acid;
an aggregate phase; and
a retarder in an amount of between about 0.05% and about 5% by weight based upon the weight of dry cement.

11. The method of claim 10, wherein the MSPC mix further includes fibers.

12. The method of claim 11, wherein the fibers are at least one of: mono-filament fibers and multi-filament fibers.

13. The method according to claim 1, further comprising:
adding to the MSPC mix one or more color pigments for achieving a desired color.

14. The method according to claim 1, further comprising:
adding to the MSPC mix one or more textural additives for achieving a desired texture.

15-20. (canceled)
